(19) United States
(12) Patent Application Publication
(10) Pub. No.: US 2009/0209042 A1
(43) Pub. Date: Aug. 20, 2009

(54) CONTROLLABLE MAGNETIC SYSTEM FOR BIOSENSORS

(75) Inventors: Petrus Johannus Wilhelmus Van Lankvelt, Boekel (NL); Menno Willem Jose Prins, Rosmalen (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/299,788

(22) PCT Filed: May 8, 2007
(86) PCT No.: PCT/IB2007/051720

§ 371 Date: Nov. 6, 2008

(30) Foreign Application Priority Data
May 10, 2006 (EP) 06113768.3
Mar. 6, 2007 (EP) 07103633.9
Apr. 27, 2007 (EP) 07107092.4

(51) Int. Cl. G01N 27/00

(52) U.S. Cl. 436/149; 422/68.1

(57) ABSTRACT

The invention relates to a magnetic system for biosensors and in particular to a magnetic system which can switch between attraction force and repulsion force near the sensor surface with more easy but also more effective means. This is realised with at least one coil (2) and at least two ferromagnetic cores (3) which are arranged in a concentric multilayered package, and a sensor or a sensor surface exposed to or covered with the biomaterial, which is arranged near to the magnetic system.

### FIELD OF THE INVENTION

The invention relates to a controllable magnetic system for biosensors.

### BACKGROUND OF THE INVENTION

Sensors for detecting biomaterial are in use in medical care in several technical applications.

Magnetic actuation is crucial in order to increase the performance of the magnetic biosensor in terms of point-of-care applications. Firstly, it speeds up the concentration and therefore the binding process of the magnetic particles at the sensor surface. Secondly, magnetic washing can replace the traditional wet washing step, which is more accurate and reduces the number of operating actions.

Compared to the chip dimensions, large external electromagnets are used for actuation in order to achieve: homogeneous field gradients (force) at the sensor surface and large penetration depths over the entire sample volume. These qualities are hard to achieve with integrated actuation structures.

For the conditioning biomaterial in order to reach an effective evaluation of biomaterial components, the biomaterial has to be brought into a closer contact to the surface of the biosensor. Therefore an attracting force to the biomaterial must be generated. This is usually realised by magnetic beads, which will be chemically or physically bound to the biomaterial. A magnetic attraction force must be generated near to the sensor surface.

The biosensors of biochips used have promising properties for bio-molecular diagnostics in terms of sensitivity, specificity, integration, ease of use and costs.

Examples of such biochips are given in WO 2003054566, which describe excitation with uniform magnetic fields.

A biosensor is based on the detection of superparamagnetic beads and may be used to simultaneously measure the concentration of a large number of different biological molecules in a solution of biomaterial.

The sensor-surface must have a close contact to the biomaterial which can be caused by bringing the biomaterial very close to the sensor surface with the help of the mentioned magnetic beads. The other side is that after measuring the biomaterial this must be washed away, in order to condition the sensor surface for the next measurement.

This can also be realised with the magnetic beads mixed with the biomaterial, thus generating a magnetic repulsion force near the sensor surface.

Normally, a magnetic force induced by a magnet or an electromagnet is directed towards the magnet. Therefore, two magnets are needed for inducing a magnetic force towards the sensor surface, the so called sedimentation, and away from the sensor surface, the so called washing.

In the publication Anal. Chem. 2004, 76, 1715-1719 the general use of magnetic beads used in biomaterial in order to bring it in a close sensor surface contact is described there.

This also encloses manners to change the magnetic field gradient in order to a kind of conditioning the molecules which have paramagnetic ligands or magnetic beads on which they are bound. The magnetic force gradient has a direct influence on this.

Thereby, also the magnetic force direction can be influenced by moving the sample between different magnets or positions.

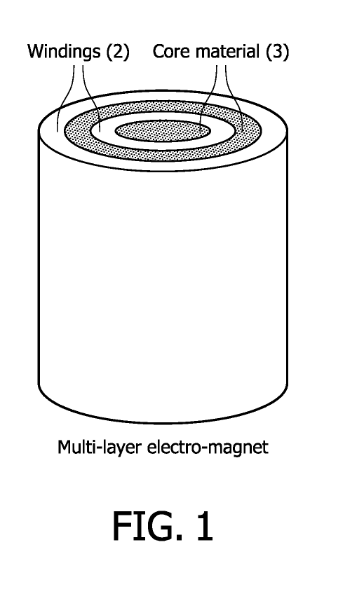

These changes cannot be achieved without mechanical movement of some components, like it is shown in FIG. 1 of this description. In electrical devices in general and electrical hand-held devices in particular such as the point-of-care application of a magnetic biosensor, the mechanical moving parts are unwanted.

### SUMMARY OF THE INVENTION

It is the object of the present invention to construct a magnetic system with the aforesaid properties which can switch between attraction force and repulsion force near the sensor surface with more easy but also more effective means.

The stated object is achieved for a magnetic system for biosensors by characterizing features of patent claim 1.

Further different embodiments of this magnetic system are characterized in the dependant claims 2-12.

The stated object is also achieved for operating a magnetic system for biosensors, by characterizing features of patent claim 13.

Further different embodiments of this method are characterized in dependent claims 14-16.

The stated object of the invention is achieved for a magnetic system for biosensors, with at least one coil and at least two ferromagnetic cores which are arranged in a concentric multilayered package, and a sensor or a sensor surface exposed to or covered with the biomaterial, which is arranged near to the magnetic system.

The essential feature of this invention is an electromagnet that has a multiple layered structure consisting of core material and windings. A picture of such an electromagnet is shown later on in FIG. 1. Normally, an electromagnet consists only of windings and sometimes a core material inside (depending on its application). With this new multiple layered structures, the shape of its generated magnetic field can be tuned and deformed in order to change the magnetic forces. This deformation of the magnetic field occurs just by varying the magnitude and direction of the currents through the different windings. The big advantage of this multiple layered electromagnet is that the shape of the magnetic field can be engineered without any mechanical movement.

This invention considers a magnet which can do it both. Besides a normal attraction

force, this magnet is also capable of applying a repulsive force which directly influences the biomaterial, this means the magnetic beads solved in it, but without any mechanical sensor or magnet movement.

In an advantageous embodiment the magnetic system for biosensors has at least one coil and at least two ferromagnetic cores which are arranged in a concentric multilayered package, and a sensor or a sensor surface exposed to or covered with the biomaterial, which is arranged near to the magnetic system.

Another alternative embodiment is, that definitively two concentric coil layers and two concentric core material layers are arranged in a multilayered package. By this the effective magnetic field generated to the sensor can be tuned electrically. That means that no mechanical movement is necessary.

In a further advantageous embodiment only one concentric coil layer and two concentric core material layers are arranged in a multilayered package. This represents a very compact magnet system. In this embodiment the two cores are connected together at the bottom of the multilayered magnet like a magnetic shortcut. This compact construction even causes a high effective magnetic force.

In a further embodiment the coils are electrically controllable independently from each other. By this the effective magnetic force and the magnetic gradient can be tuned very precisely in a very broad scale of possibilities.

In a further embodiment of the invention two coils and two magnetic cores are arranged in such a way that an inner magnetic system consisting of a coil and a magnetic core influenced by this inner coil is surrounded by an outer coil and an outer magnetic core influenced by this outer coil.

With this new multiple layered structures, the shape of its generated magnetic field can be tuned and deformed in order to change the magnetic forces as well as the resulting force directions.

This deformation of the magnetic field occurs just by varying the magnitude and direction of the currents through the different windings. The big advantage of this multiple layered electromagnet is that the shape of the magnetic field can be engineered without any mechanical movement. So this embodiment is the most advantageous one.

In a further embodiment the biomaterial is filled in a cartridge which is positioned in the area influenced by the magnetic field. So the biomaterial can be brought easily in a very close position to the magnetic field generated by the magnetic system.

In a further embodiment, an opening in the magnetic system is arranged at that side, where the sensor is located, which is created by a shift of the inner core or the inner core-coil arrangement.

According to this it is an embodiment, that the opening in the magnetic core is a cylindrical blind hole. This can easily be created by a shifted inner part of the magnetic system.

A further embodiment discloses, that the opening in the core is a cone shaped hole or opening.

Alternatively, the opening in the core can also have a rectangular or a squared cross section.

A further embodiment is described with further means by which the effective magnetic force can be increased in that adjacent to the magnet a second magnet is arranged, separated over a gap.

The sensor can be designed as an array of several sensors.

The stated object of the invention is achieved also for a method of operating a magnetic system for biosensors as described in one of the aforesaid claims, by which a sensing material or liquid is dispersed with or chemically bound to microscopic magnetic beads, and the sensor chip is positioned in such a position, that by generating magnetic repulsion near the sensor surface area a washing of the surface by repulsion forces of the magnetic beads is caused, and that by generating magnetic attraction forces near the sensor surfaces area attraction forces to the magnetic beads are caused for sensing the biosubstrate in a very close contact to the sensor surface.

The very compact magnetic system as well as the way of controlling the coils causes the possibility to switch between different magnetic force orientations without mechanical means.

For realising this the inner coil or coil layer is applied with a current, or with a dominating current in comparison with the current in the outer coil, in order to produce a repulsive magnetic force.

The switch into the other magnetic force direction is generated in that way, that the outer coil or coil layer is applied with a current, or with a dominating current in comparison with the current in the inner coil, in order to produce an attractive magnetic force.

In a further embodiment of the inventive method a soft switch between repulsive magnetic force and attractive magnetic force can also be controlled, which is generated by a balance control of the currents amperage and/or currents polarity.

Thereby, the system can switch easily between repulsion and attraction force by using this concentric magnetic system which has a multiple layered system of at least two concentric coils and two ferromagnetic cores, wherein the inner coil-core-arrangement is shorter than the outer coil-core-arrangement, in order to create that aforesaid opening at that side where the sensor is located.

The sensor surface must have a close contact to the biomaterial which can be caused by bringing the biomaterial very close to the sensor surface with the help of the mentioned magnetic beads. The washing is used to remove the unbound and non-specific bound beads from the sensor surface for proper end-point measurement.

By this the aforesaid opening in the magnetic core the system can work very effective in this embodiment. This opening can be a cylindrical blind hole, and another advantageous opening in the core is a cone shaped hole or opening. Further, advantageous cross sections of openings are rectangular or square.

These two alternatives, this means the multilayered magnetic system without opening, and the multilayered system with opening both realise the great advantage that no sensor or magnet movement is necessary.

For the advantageous use for biosensors, an embodiment of the invention discloses that the sensor is designed as an array of several sensors. This results in a very effective sensor with a big resulting sensor-active surface.

Different embodiments of the invention are shown in FIG. 1 to FIG. 5.

FIG. 1 multiple layered system with two concentric coils and two cores

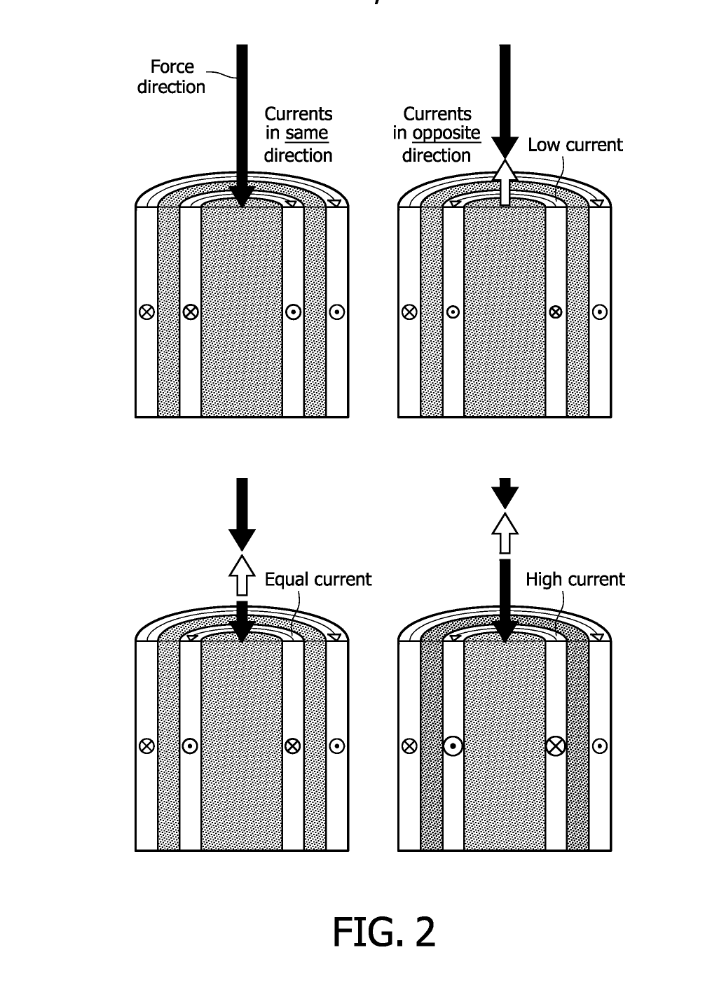

FIG. 2 cut through the magnetic system according to FIG. 1

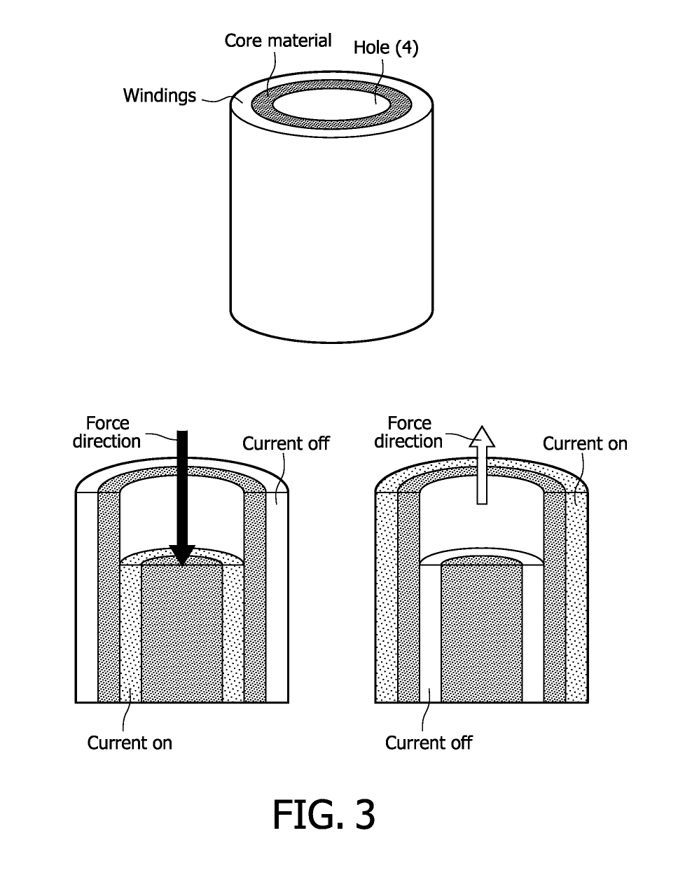

FIG. 3 multilayered magnetic system with an opening

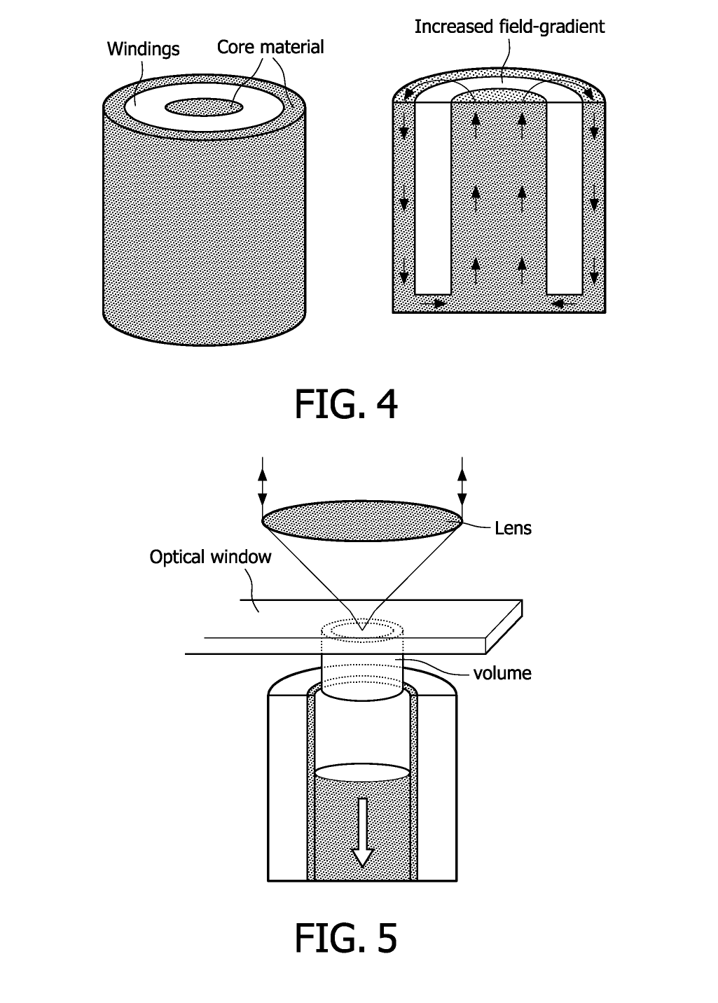

FIG. 4 system of one coil with two cores with magnetic shortcut

FIG. 5 sensor chip close to the magnetic pole surface (optional optical means)

FIG. 1 shows the essential feature of this invention which is an electromagnet 1 that has a multiple layered structure consisting of core material layer 3 and windings, that means coils 2. A picture of such an electromagnet 1 is shown in FIG. 1. Normally, an electromagnet 1 consists only of windings and facultative a core material inside (depending on its application). With this new multiple layered structures, the shape of its generated magnetic field can be tuned and deformed in order to change the magnetic forces. This deformation of the magnetic field occurs just by varying the magnitude and direction of the currents through the different windings. The big advantage of this multiple layered electromagnet is that the shape of the magnetic field can be engineered without any mechanical movement. The electromagnet consists of two separate layers of windings 2 and two layers of core material 3. By varying the magnitudes and directions of the different currents through both windings, the magnetic field can be deformed. This deformation makes this electromagnet useful for many different applications without using any mechanical step.

FIG. 2 shows cross sections of the multilayered electromagnet where the amplitudes and directions of the different current are varied in order to create and affect an attractive magnetic force area. (a) Both currents in same direction: common electromagnet behaviour. (b-d). Both currents in opposite direction: a repulsive magnetic force component area is created. The position of this area can be tuned by varying the amplitude of both currents with respect to each other.

This embodiment describes a manner to use the multilayered electromagnet as is shown in FIG. 1. This multilayered electromagnet acts like a normal electromagnet when the currents through both layers of winding are in the same direction like already mentioned. This common electromagnet behaviour is shown in FIG. 2a. By changing the direction of one of the currents (for example the current of the inner windings), the shape of the magnetic field will be affected and the changed field gradient creates a certain area where the magnetic force is directed away from the electromagnet. This principle is shown in FIG. 2b-d. By changing the amplitude of both currents with respect to each other, the position of this repulsive area can be tuned. If the inner current is small compared to the other current, the repulsive area is just above the electromagnet surface (FIG. 2b). By increasing this inner current with respect to the outer current, the repulsive area is shifted up (FIG. 2c-d).

This phenomenon can apply a repulsive magnetic force in a region that is not in close contact with the electromagnet. This becomes important if spacing between the sensor surface and the electromagnet is large due to for example a relative thick (robust) cartridge.

So it is very advantageous that not only the orientation of the resulting magnetic gradient vector can be influenced without mechanical means, but also the distance or spacing of the magnetic force region.

FIG. 3 shows an embodiment which encloses a multilayered electromagnet where the two inner layers (one core material and one winding layer) are somewhat shorter, which is creating a hole in the centre of the multilayered electromagnet. A drawing of this is shown in FIG. 3a. By placing the sensor chip inside the hole 4 and turn on the current through the outer layer of windings, a repulsive force is generated above the surface (FIG. 3c). This embodiment prevents this movement by turning off the current through the outer windings and by turning on the current through the inner windings (FIG. 3b). This inner structure acts like a normal electromagnet and induces a normal attractive magnetic force.

FIG. 3(a) shows a drawing of a multilayered electromagnet with shortened inner layers, which is therefore creating the hole in the centre. (b) If a current is applied through the inner layer of windings (no current through the outer windings), it acts like a normal electromagnet and generates an attractive magnetic force. (c) If a current is applied through the outer layer of winding, a repulsive magnetic force is generated.

This embodiment does not need any mechanical movement of the sensor or the magnetic system. Instead of this the magnetic force direction is switched by turning off the current through the outer windings and by turning on the current though the inner windings (FIG. 3b).

This inner structure acts like a normal electromagnet and induces a common attractive magnetic force.

FIG. 4 shows an embodiment which encloses a multilayered electromagnet, which consists of two layers of core material and one layer of windings. A drawing of this is shown in FIG. 4a. The two layers of core material 3 are connected at the bottom of the electromagnet, which is shown by the cross section of the multilayered electromagnet (FIG. 4b). This structure acts like a magnetic shortcut and creates an increased magnetic field gradient. The magnetic force is increased by factor of approximately four due to this strong gradient. There are two big advantages by increasing the magnetic force by stronger gradients instead of stronger fields:
A stronger field is requiring stronger currents and therefore higher power consumption, while a stronger gradient does not need a higher current. By keeping the magnetic force constant, the power consumption can be reduced by this structure.
A strong magnetic field eventually saturated the core material and the manipulated magnetic particles, which reduce the efficiency of the consumed power with respect to the generated force. A field gradient has no limitation by any saturation effect.

So the drawing of the multilayered electromagnet with two layers of core material 3 and one layer of windings 2 shows the two layers of core material 3 which are connected at the bottom that acts like a magnetic shortcut, which increases the magnetic field gradient and thereby the magnetic force by a factor of approximately four.

The magnitude of the magnetic force is very important for the desired effect of sedimentation and washing. The force is linear proportional to the speed of the magnetic beads and therefore also to the sedimentation time. More important is that a certain force has to be overcome in order to wash the non-specific beads from the surface. Using a second coil can boost the force.

The sensor can be any suitable sensor to detect the presence of magnetic particles on or near to a sensor surface, based on any property of the particles, e.g. it can detect via magnetic methods for example magnetoresistive methods, Hall methods, coils etc, as well as optical methods like imaging, fluorescence, chemiluminescence, absorption, scattering, surface plasmon resonance, Raman, etc. Also sonic detection is possible, that means generation and detection of surface acoustic wave, bulk acoustic wave, cantilever, quartz crystal etc., as well as electrical detection like conduction, impedance, amperometric, redox cycling, etc.

The labels can be detected directly by the sensing method. As well, the particles can be further processed prior to detection. An example of further processing is that materials are added or that the chemical, biochemical or physical properties of the label are modified to facilitate detection.

The detection can occur with or without scanning of the sensor element with respect to the biosensor surface. In addition to molecular assays, also larger moieties can be detected, e.g. cells, viruses, or fractions of cells or viruses, tissue extract, etc.

Measurement data can be derived as an end-point measurement, as well as by recording signals kinetically or intermittently.

The device and method can be used with several biochemical assay types, e.g. binding/unbinding assay, sandwich assay, competition assay, displacement assay, enzymatic assay, etc.

The device, methods and systems of this invention are suited for sensor multiplexing, for example the parallel use of different sensors and sensor surfaces, label multiplexing for example the parallel use of different types of labels, and chamber multiplexing for example the parallel use of different reaction chambers.

The device, methods and systems described in the present invention can be used as rapid, robust, and easy to use point-of-care biosensors for small sample volumes. The reaction chamber can be a disposable item to be used with a compact reader, containing the one or more magnetic field generating means and one or more detection means. Also, the device, methods and systems of the present invention can be used in automated high-throughput testing. In this case, the reaction chamber is e.g. a well plate or cuvette, fitting into an automated instrument.

FIG. 5 also shows optical means for the aforesaid optical or optoelectronical detection. The optical means are located above the sample volume which can be located in or near above the opening of the magnet system.

Optical labels offer some desirable properties:
Many detection possibilities like imaging, fluorescence, absorption, scattering, turbidometry, SPR, SERRS, luminescence, chemiluminescence, electrochemiluminescence, FRET, etc.
Imaging possibility offers high multiplexing.
Optical labels are generally small and do not influence the assay too much.

A good combination would be to use magnetic labels that can be actuated by applying magnetic field gradients and that can be detected optically. An advantage is that optics and magnetics are orthogonal in the sense that in most cases optical beams do not show interference with magnetic fields and vice versa. This means that magnetic actuation would be ideally suited for combination with optical detection. Problems such as sensor disturbance by the actuation fields are eliminated.

The problem of combining magnetic actuation and optical detection is in the geometrical constraint. To develop a cartridge technology that is compatible with magnetic actuation means, typically an electromagnet needs to operate at a small distance between magnet and sensor surface. An optical system needs to scan the same surface, possible with high-NA optics. The optomechanical set up and the electromagnet therefore hinder each other when integrating a concept with magnetic actuation and optical detection. Preferably, a configuration with a magnet on only one side is needed. This magnet is be able to generate a switchable magnetic field.

The multilayered electromagnet was developed a.o. for a magnetic biosensor platform. Magnetic manipulation of the beads can be used to achieve a higher speed, more accurate washing and less fluid manipulation steps.

1. A magnetic system for biosensors, with at least one coil (2) and at least two ferromagnetic cores (3) which are arranged in a concentric multilayered package, and a sensor or a sensor surface exposed to or covered with the biomaterial, which is arranged near to the magnetic system.

2. A magnetic system, according to claim 1, characterized in that the coil (2) comprises two concentric coil layers and the core (3) comprises two concentric core material layers which are arranged in a multilayered package.

3. A magnetic system, according to claim 1, characterized in that one concentric coil layer and two concentric core material layers are arranged in a multilayered package, wherein the two core material layers are connected together at the bottom of the magnet system.

4. A magnetic system, according to claim 2, characterized in that the coils (2) are electrically controllable independently from each other.

5. A magnetic system according to claim 1, characterized in that two coils (2) and two magnetic cores (3) are arranged in such a way, that an inner magnetic system consisting of a coil (2) and a magnetic core (3) influenced by this inner coil is surrounded by an outer coil and an outer magnetic core is influenced by this outer coil (2).

6. A magnetic system according to claim 1, characterized in that the biomaterial is filled in a cartridge which is positioned in the influence area of the magnetic field.

7. A magnetic system according to claim 1, characterized in that an opening in the magnetic system is arranged at that side, where the sensor is located, which is created by a shift of the inner core (3) or the inner core-coil arrangement.

8. A magnetic system for biosensors according to claim 7, characterized in that the opening in the magnetic core (3) is a cylindrical blind hole.

9. A magnetic system for biosensors according to claim 7, characterized in that the opening in the core (3) is a cone shaped hole or opening.

10. A magnetic system for biosensors according to claim 7, characterized in that the opening in the core (3) has a rectangular or a squared cross section.

11. A magnetic system for biosensors according to claim 1, characterized in that adjacent to the magnet a second magnet is arranged, separated over a gap.

12. A magnetic system for biosensors according to claim 1, characterized in that the sensor is an array of several sensors.

13. Method for operating a magnetic system with biosensor as described in claim 1, by which a sensing material or liquid is dispersed with or chemically bound to microscopic magnetic beads, and the sensor chip is positioned in a such a position, that by generating magnetic repulsion near the sensor surfaces area is caused a washing of the surface by repulsion forces of the magnetic beads, and that by generating magnetic attraction forces near the sensor surfaces area is caused attraction forces to the magnetic beads for sensing the biosubstrate in a very close contact to the sensor surface.

14. Method according to claim 13, characterized in that the inner coil (2) or coil layer is applied with a current, or with a dominating current in comparison with the current in the outer coil (2), in order to produce a repulsive magnetic force.

15. Method according to claim 13, characterized in that the outer coil (2) or coil layer is applied with a current, or with a dominating current in comparison with the current in the inner coil (2), in order to produce an attractive magnetic force.

16. Method according to claim 14, characterized in that a soft switch between repulsive magnetic force and attractive magnetic force is generated by a balance control of the currents amperage and/or currents polarity.
